(19) United States
(12) Patent Application Publication
(10) Pub. No.: US 2003/0206596 A1
(43) Pub. Date: Nov. 6, 2003

(54) Multimedia content assembly

(76) Inventors: David Carver, Lexington, MA (US); Branko J. Gerovac, Lexington, MA (US)

Correspondence Address: FISH & RICHARDSON PC, 225 FRANKLIN ST, BOSTON, MA, 02110, US

(21) Appl. No.: 10/138,552

(22) Filed: May 3, 2002

(51) Int. Cl. H04N 7/12

(52) U.S. Cl. 375/240.26

(57) ABSTRACT

A method for assembling multimedia streams enables assembly of any of a number of possible output multimedia streams from segments of source multimedia streams. Enabling assembly of the streams includes computing stream fragments for insertion between successive of the segments to form any of the output streams. According to such a method, computation required for creating transition points in source MPEG streams can be largely performed as a preprocess that produces data that can be stored for use in later assembling a stream, assembly of a stream requires relatively little computation and can be implemented using relatively inexpensive equipment, for example, in software.

### BACKGROUND

This invention relates to assembly of multimedia content.

The MPEG (Motion Picture Expert Group) standards include specifications for the format of multimedia streams. One aspect of the specifications is for compressed encoding of video streams. Another aspect of the specification is for a transport stream that carries video and audio streams for programs. Such transport streams are often used to deliver television programming in cable television systems.

Various approaches have been proposed for splicing MPEG streams. In general, such approaches require processing the streams when the splice is made. Some approaches to splicing compressed MPEG video streams involve decoding and then re-encoding portions of the streams to form the splice. Some approaches to splicing of MPEG streams involve modifying the steams and creating allowable points at which transitions may be made.

### SUMMARY

In one aspect, in general, a method for assembling multimedia streams enables assembly of any of a number of possible output multimedia streams from segments of source multimedia streams. Enabling assembly of the streams includes computing stream fragments for insertion between successive of the segments to form any of the output streams.

The method can include one or more of the following features:

The method includes determining the segments of the source streams from desired presentation time boundaries for those segments.

At least some of the stream fragments are stored prior to assembly.

The stream fragments are stored in a disk storage.

The stream fragments are for concatenation between successive segments.

The stream fragments are for concatenation without modification to form any of the output streams.

Each of the source multimedia streams, each of the output multimedia streams, and each of the stream fragments include temporally encoded streams, such as MPEG streams.

Each of the MPEG streams includes an MPEG transport stream.

The output streams include video streams such that each video stream encodes a presentation of a continuous sequence of video frames.

The video streams avoid overflow or underflow of a Video Buffer Verifier model.

The method further includes assembling a first of the output multimedia streams from a series of the segments.

Computing the stream fragments is performed prior to assembling transitions between segments of the first output stream.

Computing the stream fragments is performed independently of assembling the first output stream.

At least some of the stream fragments are stored, and assembling the first output stream includes retrieving those fragments.

Assembling the first output stream includes inserting one or more of the stream fragments between each successive pair of the segments in the series.

Inserting the stream fragments between each successive pair of segments includes inserting the two stream fragments between said segments.

Assembly of the output stream includes concatenating the two stream fragments.

A second of the output multimedia streams is assembled from a series of segments.

At least some of the computed stream fragments are inserted into both the first output stream and the second output stream.

A first set of the output multimedia streams is assembled and at least some of the computed stream fragments are not used in assembling any of the streams of that first set.

Enabling assembly of any of the output streams includes enabling assembly of a succession of any of a first set of the stream segments and any of a second set of stream segments.

Computing the stream fragments includes computing stream fragments each associated with a transition from a different one of the first set of segments, and computing stream fragments each associated with a transition to a different one of the second set of stream segments.

In another aspect, in general, the invention features method for dynamic assembly of multimedia streams. Information for each of a set of replacement segments is stored, including for each replacement segment, a stream fragment associated with the beginning of the replacement segment and a stream fragment associated with the end of the replacement segment. For each of one or more original segments of a source multimedia stream, the original segment is replaced with one of the stored replacement segments. Replacing the segment includes inserting a stream fragment associated with each of the original segment and the replacement segment at each transition between the source stream and the replacement segment.

In another aspect, in general, the invention features a method for assembling a multimedia stream. The method includes identifying transition points in one or more multimedia streams. This includes identifying a first transition point in a first of the streams and a second transition point in a second of the streams. Stream fragments each associated with one of the transition points in the streams are computed. This includes computing a first stream fragment associated with the first transition point in the first stream and computing a second stream fragment associated with the second transition point in the second stream. The multimedia stream is assembled from a number of elements, which include, a portion of the first stream prior to a first transition point, the first stream fragment, the second stream fragment, and a portion of the second stream following the second of the transition point.

Among the advantages of the invention are one or more of the following:

Because computation required for creating transition points in source MPEG streams can be largely performed as a preprocess that produces data that can be stored for use in later assembling a stream, assembly of a stream requires relatively little computation and can be implemented using relatively inexpensive equipment, for example, in software.

The computation of the fragments can be performed independently of assembling the transitions, therefore the computation can be performed earlier or on a different computer than used for the assembly process.

The same precomputed fragments can be used to assemble different output streams, thereby reducing the total amount of computation.

The approach provides an economical way to replace or insert advertising in a television program. Because of the low complexity of inserting an advertising segment, a large number of different advertising streams can be economically provided.

In a system in which multiple different streams are delivered to different subscribers, such as in a video-on-demand system, the invention provides a way of economically assembling the streams for different subscribers. For example, each video-on-demand stream may have a different set of advertising inserted into it that may be specifically targeted to the subscriber.

The approach avoids underflow of a decoder buffer when presenting the assembled stream. Objectionable artifacts that result from underflow in some decoder implementations can be avoided.

The approach enables a “coherent” stream to be assembled such that video picture presentation is continuous and regular at expected intervals across transitions between any combination of source segments.

The approach can be applied to source multimedia streams that have not necessarily been prepared or modified to facilitate forming of transitions, and can be used to allow additional transition points in which some allowable transition points have previously been created.

Other features and advantages of the invention are apparent from the following description, and from the claims.

### DESCRIPTION OF DRAWINGS

FIG. 1 is a diagram that illustrates assembly of a multimedia transport stream;

FIG. 2 is a diagram that illustrates an out-transition fragment;

FIG. 3 is a diagram that illustrates an in-transition fragment;

FIG. 4 is a diagram that illustrates MPEG frames in a video stream of an out-transition fragment;

FIG. 5 is a diagram that illustrates MPEG frames in a video stream of an in-transition fragment;

FIG. 6 is a diagram that illustrates transport stream packets near a boundary between an out-transition fragment and an in-transition fragment;

FIG. 7 is a diagram that illustrates delivery and presentation timing of frames near a boundary between an out-transition fragment and an in-transition fragment;

FIG. 8 is a system block diagram;

FIG. 9 is a diagram that illustrates an advertising insertion procedure;

FIG. 10 is a block diagram of a set-top box; and

FIG. 11 is a diagram that illustrates an advertisement replacement system.

### DESCRIPTION

1Content Assembly with Transition Fragments

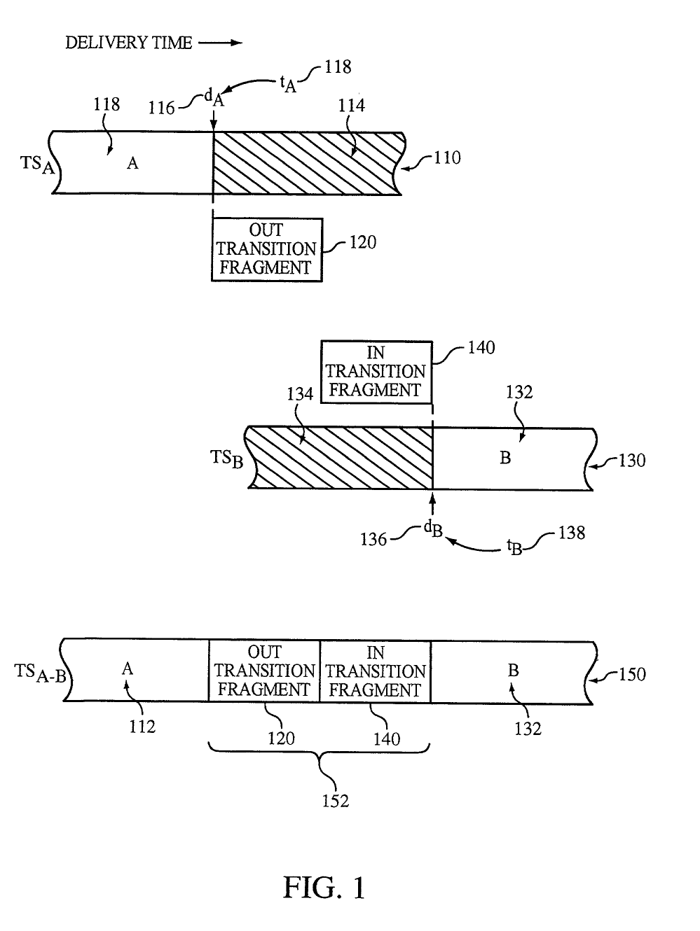

Referring to FIG. 1, an approach to multimedia content assembly involves combining segments of a number of source MPEG transport streams to form a new assembled MPEG transport stream. In FIG. 1, three MPEG transport streams are illustrated with the delivery time of the streams flowing from left to right (the delivery times for the different streams are not aligned). These include two source streams, TS_{A} 110 and TS_{B} 130, and a new (assembled) stream TS_{A-B} 150. Combining desired segments of the source streams involves switching from one source stream to another during the assembly process. In the vicinity of a transition from source stream TS_{A} 110 to source stream TS_{B} 130, new stream TS_{A-B} 150 includes:

(1) a segment 112 of transport stream TS_{A} 110 that approximately corresponds to content that would have been presented up to a desired presentation “out time” t_{A} 118 in that stream,

(2) a transition portion 152, which when decoded and presented results in a short black interval, and

(3) a segment 132 of transport stream TS_{B} 130 that approximately corresponds to content that would have been presented starting at a desired presentation “in time” t_{B} 138 in that stream.

The transition portion that is inserted between the two source transport streams results in a presentation interval that is viewed for a short time between the source streams. For example, in a transition from a television program to a commercial, a brief interval of black video and silent audio is presented. Also, the source streams are not necessarily switched at frames that correspond exactly to the desired in and out times.

As a first step of assembling transport stream TS_{A-B} 150 at a transition from stream TS_{A} 110 to stream TS_{B} 130, the desired out time t_{A} 118 and in time t_{B} 138 are mapped to offsets in the transport streams (e.g., byte offsets relative to the start of the steam) that are associated with those times. These desired transition times (the in and out times) therefore determine the endpoints of the segments of the streams that will form the transition and the endpoints of the segments approximately correspond to these desired transition times. In this example, out time t_{A} 118 is mapped to an offset d_{A} 116 in stream TS_{A} 110 and in time t_{B} 138 is mapped to an offset d_{B} 136 in stream TS_{B} 130. A discussion of this mapping procedure is deferred until later in this description.

Transition portion 152 is made up of a concatenation of an out-transition fragment 120, which is associated with an “out” transition at offset d_{A} 116 in TS_{A} 110 to another stream, and an in-transition fragment 140, which is associated with a transition from another stream to TS_{B} 130 at offset d_{B} 136.

Out-transition fragment 120 for TS_{A} is pre-computed independent of the assembly processes, and is formatted as a transport stream such that a switching from TS_{A} 110 at offset d_{A} 116 to out-transition fragment 120 does not disrupt the formatting of the resulting transport stream. That is, various level of packet and frame structure in the transport stream remain properly formatted as the transport stream is switched at offset d_{A} 116 without requiring examination of the content of the stream at the time of assembly. This proper formatting ensures that an MPEG compliant decoder receiving transport stream TS_{A-B} should be able to correctly decode and present the assembled program.

In-transition fragment 140 is also pre-computed independent of the assembly processes, and is formatted as a transport stream such that switching from out transition fragment 120, or in general switching from any similarly constructed out transition fragment corresponding to a different out point, to in-transition fragment 140 also does not disrupt the formatting of the resulting transport stream.

In the new transport stream TS_{A-B} 150, in-transition fragment 140 is concatenated after out-transition fragment 120, and then portion 132 of TS_{B} 130 is concatenated after the transition fragments. This resulting transport stream TS_{A-B} 150 is a compliant MPEG transport stream. As is discussed further below, compliance includes the assembled video streams satisfying a standard video buffer verifier (VBV) model, thereby ensuring that a MPEG compliant video decoder that receives the assembled video stream should not overflow or underflow. Compliance also includes ensuring the assembled stream contains no video discontinuities.

Together, the concatenation of out-transition fragment 120 and in-transition fragment 140 form a transition fragment that joins the desired portions 112 and 132 of the original streams. Note that simple abutting of portions 112 and 132 of the source transport streams would not generally form a valid MPEG transport stream. For example, at offset d_{A} 116 in TS_{A} 110 there are in general a number of partial packets and frames which would not be completed appropriately in portion 132 of TS_{B} 130 which follows offset 136. Furthermore, even if the packet and frame structure were valid after concatenation, there would be a possibility that a decoder receiving the stream would suffer from buffer over- or under-flow because the encoder that generated desired portion 132 assumed a different state of the decoder at the start of that portion.

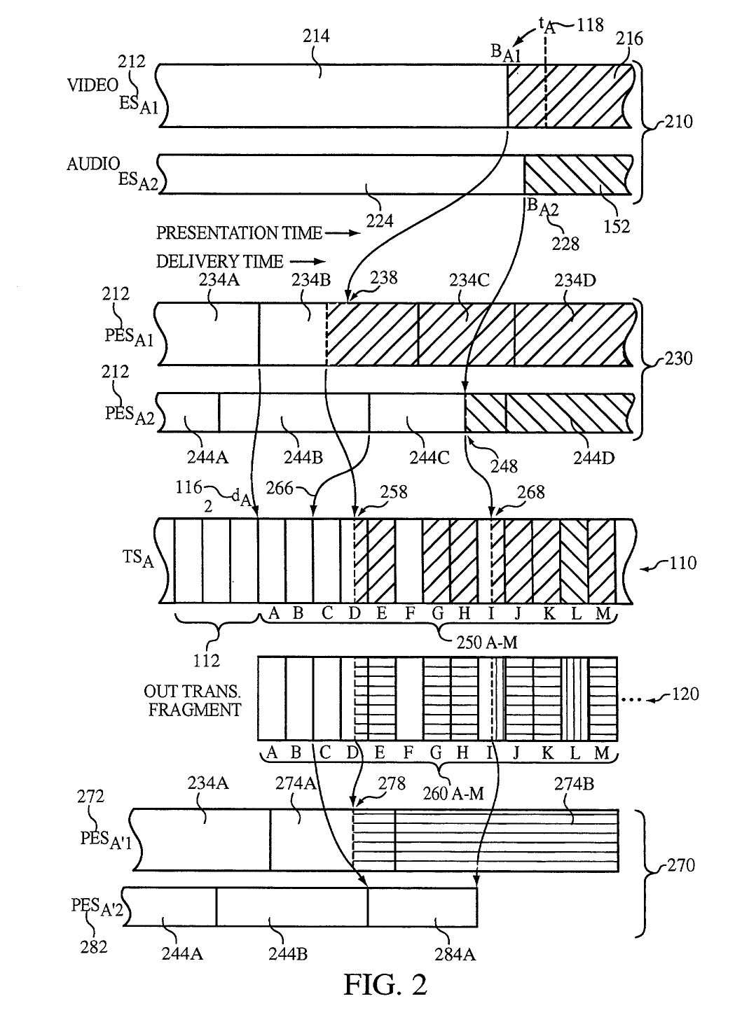

Referring to FIG. 2, an MPEG encoded program 210, which is carried in transport stream TS_{A} 110, is typically made up of a number of elementary streams (ES). For example, a television program typically includes a video elementary stream, and one or more audio elementary streams. In FIG. 2, a representative pair of streams is illustrated as a video stream ES_{A1} 212 and an audio stream ES_{A2} 222 along a time axis corresponding to the presentation time of the streams. Note that in general, an MPEG program may include additional elementary streams. For example, a number of different audio streams may each correspond to a different language or a different audio compression standard. Multiple video streams may correspond to different camera angles or to different aspect ratios.

Elementary streams ES_{A1} 212 and ES_{A2} 222 are made up of a series of frames (not indicated in FIG. 2). The desired out time t_{A} 110 is used to compute a frame offset f_{A1} 218 in ES_{A1} 212 and a frame offset f_{A2} 228 in ES_{A2} 222. The details of this mapping process are deferred to later in this description. In FIG. 2, a portion 214 of ES_{A1} 212 corresponds to encoded video of program 210 that is retained in the assembled stream, and portion 216 of ES_{A2} 222 corresponds to video that is not retained if the transition is used. Similarly, a portion 224 corresponds to audio of program 210 that is retained, and a portion 226 corresponds to audio that is not retained if the transition is used.

The elementary streams for program 210 are carried in corresponding packetized elementary streams (PES) 230. Packetized elementary streams PES_{A1} 232 and PES_{A2} 242 carry elementary video stream ES_{A1} 212 and audio stream ES_{A2} 222, respectively. Each packetized elementary stream is made up of a series of packets, which typically have variable length. As illustrated, PES_{A1} 232 includes a series of packets 234A-D and PES_{A2} 242 includes a series of packets 244A-D. Each PES packet includes a header (not illustrated) and a payload that carries the data for the corresponding elementary stream. The header of each packet indicates the size of the packet and optionally includes timing information that identifies the presentation time and delivery time of the frames in that packet.

When transport streams are received at a decoder, the elementary audio and video streams are buffered and delivered to their respective decoders after a delay, which is in general time varying and different for each elementary stream. The delay for video data is typically longer than for audio data, therefore the video data prior to out frame f_{A1} 218 occurs at a data offset 238 in PES_{A1} 232, which is delivered earlier than data offset 248 of PES_{A2} 242, which corresponds to out frame f_{A2} 228. Note that as illustrated, and in general, the out frames do not occur at boundaries of PES packets. As illustrated, data offset 238 occurs part way through PES packet 234B, and data offset 248 occurs part way through PES packet 244C.

The packetized elementary streams for a program are multiplexed into a series of fixed length (188 byte) transport packets to form transport stream TS_{A} 110 for the program. Each TS packet has a short header and a payload. Each PES packet is transported in the payload portion of multiple transport stream (TS) packets, and packets from different PES streams are interleaved in different TS packets. The start of each PES packet starts at the beginning of a corresponding TS packet payload.

The start of PES packet 234B, which is the PES packet containing the start of out frame f_{A1} 218, occurs at d_{A} 116 in TS_{A} 110, and the start of PES packet 244C, which contains the start of out frame f_{A2} 228, occurs at data offset 266 in TS_{A} 110. Data offset d_{A} 116 is chosen to be the start of a TS packet such that the TS packets that carries the starts of PES packets 234B and 244C occur no earlier than d_{A} 116.

The portion of TS_{A} 110 starting at d_{A} 116 includes a sequence of TS packets 250A-M. In this example, packets 250A-B contains an initial portion of PES packet 234B that corresponds to video prior to out frame f_{A1} 218. Packet 250C and 250F include an initial portion of PES packet 244C, which corresponds to audio prior to out frame f_{A2} 228. Packet 250D includes the start of out frame f_{A1} 218 and therefore includes data that are not retained in the assembled stream if this transition point is used. Such a packet that includes the start of out frame f_{A1} 218 may also includes data for video frames prior to f_{A1} 218, as is illustrated in the figure, that are retained in the assembled stream. Packets 250E, G, J, K, and M includes data for video frames in or after f_{A1} 218. Packet 250L includes audio frames that are in or after f_{A2} 228.

Assembly occurs at the transport stream level without requiring interpretation at the PES or ES level at the time the new stream is being assembled. Out-transition fragment 120 is aligned to a boundary of a TS packet, and is formed of an integral number of complete TS packets 260A-M. New PES streams 270 are formed by replacing TS packets starting at packet 250A in TS_{A} 110 with TS packets 260A-M of out-transition fragment 120. A PES stream PES_{A′1} 272 forms part of the new video stream (ending part way through a transition) and stream PES_{A′2} 282 forms part of the new audio stream. PES_{A′1} 272 carries a copy of the complete original PES packet 234A of PES_{A1}, 232, and some number of new PES packets, illustrated as new PES packets 274A and 274B. PES_{A′2} 282 carries copies of the complete original PES packets 244A-B and some number of new PES packets, illustrated as new packet 284A. Out-transition fragment 120 is constructed such that there is no partially delivered PES packet when the last byte of the out-transition fragment has been delivered.

Out-transition fragment 120 typically includes data in audio and video frames from ES_{A1} 212 and ES_{A2} 222 that have presentation times prior to out frames f_{A1} 218 and f_{A2} 228, respectively, but that occur after offset d_{A} 116 in transport stream TS_{A} 110.

Out-transition fragment 120 generally carries at least one newly constructed PES packet for each PES stream. As illustrated, out-transition fragment 120 includes two PES packets 274A-B for PES stream PES_{A′1} 272 and one new PES packet 284A for PES stream PES_{A′2} 282. PES packet 274A includes an initial portion that carries data of video source PES packet 234B that have presentation times prior to out frame f_{A1} 218. This initial portion ends at offset 278 in PES_{A′1} 272.

The remaining portions of PES stream PES_{A′1} 272, which occurs starting at offset 278 and ends in the out-transition fragment 120, carries video data that will be presented in the transition between source programs. This video data carries black frames. The audio stream is terminated after out frame f_{A2} 228, which results in an audio decoder underflowing during the transition period and therefore presenting silence to the viewer. The frames and PES and TS packets are formed such that after the end of out-transition fragment 120 is delivered, a video buffer verifier model of a decoder is in a known state with respect to the number of buffered (delivered but not yet presented) video frames and the amount of data buffered to represent the buffered frames. This procedure includes adding a number of null packets to the end of out-transition fragment 120 (null packets are not shown) in order to control the end of the deliver time of the out-transition fragment. The computation of the number of null packets is discussed further below.

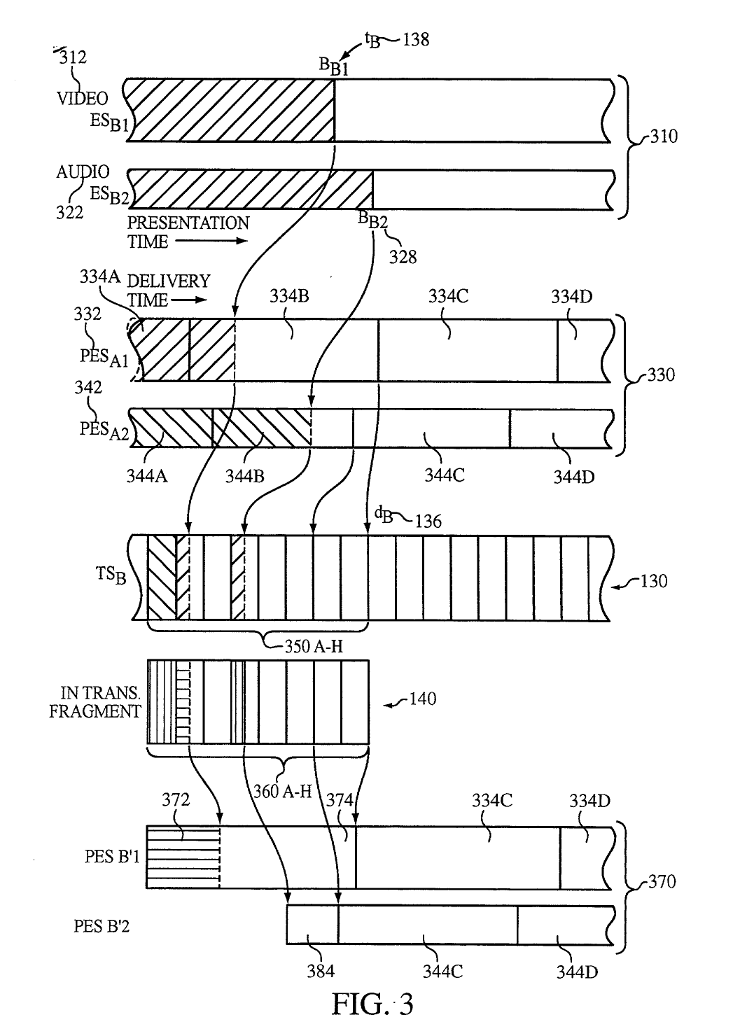

Referring to FIG. 3, the program being switched to at a transition is also carried in layered PES and TS packets. Transport stream TS_{B} 130 carries PES streams 330, which carry elementary streams 310. The desired in time t_{b} 138 is mapped to in frames f_{B1} 318 and f_{B2} 328 for elementary streams ES_{B1} 312 and ES_{B2} 322, respectively. Packetized streams PES_{B1} 332 and PES_{B2} 342 carry PES frames 334A-D and 344A-D, respectively, and in frames f_{A1} 318 and f_{A2} 328 occur in PES packets 334B and 344B, respectively.

In-offset d_{B} 136 corresponds to the first byte of a TS packet of TS_{B} 130 that occurs after the last TS packet that carries any data from the source stream that needs to be modified to achieve a valid transition. In this case, d_{B} 136 occurs after the later of the TS packet carrying the last of PES packet 334B and 344B. As illustrated in FIG. 3, in-offset d_{B} 136 is at the beginning of the first TS packet following the last TS packet that carries a PES packet which includes any data in frames prior to the in frame for the corresponding elementary stream.

As with out-transition fragment 120, in-transition fragment 140 includes an integral number of TS packets 360A-H. These packets carry modified PES packets that contain the trailing portions of PES packets 334B and 344B such that when the in-transition fragment is concatenated with TS_{B} 130 starting at offset d_{B} 136, the PES packet structure is valid. Concatenating the in-transition fragment and the out-transition fragment results in the last TS packet of the out-transition fragment being directly followed by the first TS packet of the in-transition fragment. The headers of PES packets 334B and 344B are modified in in-transition fragment 140 so that they correctly reflect the characteristics (e.g., the length and any time stamps) of the data in frames that present after f_{B1} and f_{B2}. For frames prior to in frames f_{B1} and f_{B2}, the in-transition carries PES packets 374 and 384, which carry data for transition frames, as well as data in or after the in-frames. As is discussed further below, the transition frames are computed such that the decoder is in a known state just before delivery of in frames f_{B1} and f_{B2}, for instance, ensuring that the decoder buffer will neither overflow or underflow.

2Transition Fragments

As introduced above, out-transition fragments 120 and in-transition fragments 140 are pre-computed independently of the assembly process. Computation of a transition fragment includes processing the elementary streams at the frame level such that in any transition, a valid sequence of frames is delivered to a decoder receiving the stream.

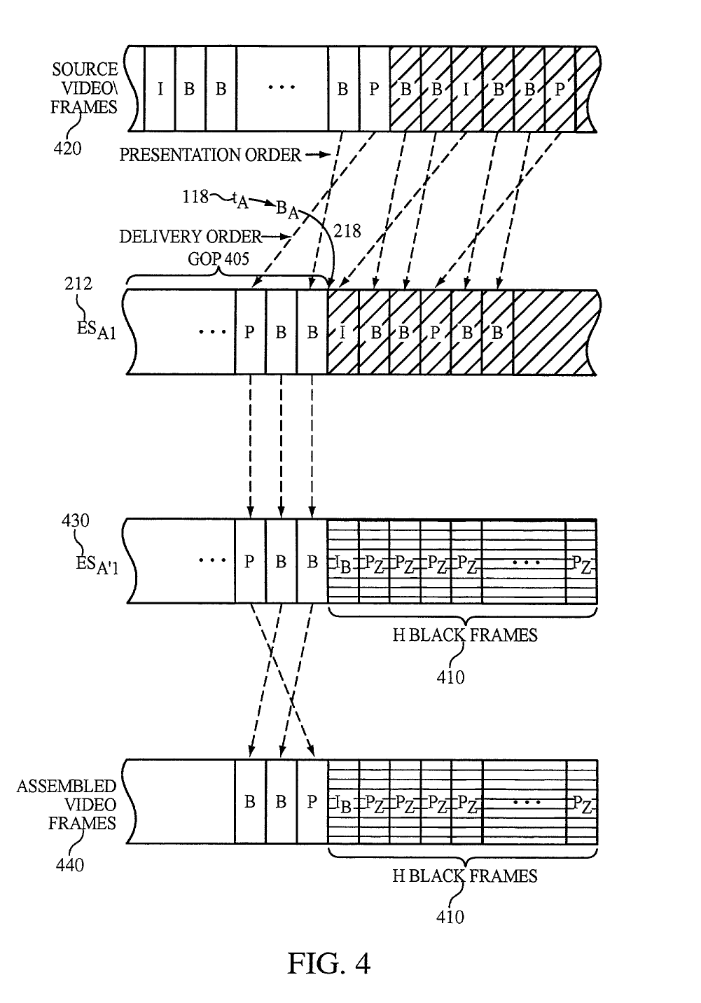

Referring to FIG. 4, a sequence of source video frames 420, which is illustrated in the presentation order for those frames, is made up of different types of frames according to standard MPEG encoding. MPEG encoding involves a temporal encoding of a series of video pictures such that the encoding of one picture may depend of the encoding of one or more other pictures. In an MPEG encoding, I-frames each fully encodes a picture, while P- and B-frames are predictive in that each encodes a picture based on a difference from a number of preceding or following pictures. P-frames are forward predicted from a previous picture, which could be encoded in an I-frame or a P-frame. B-frames are bidirectionally predicted from an earlier and a later picture that is encoded in an I-frame or a P-frame.

Elementary video stream ES_{A1} 212, which is illustrated in the delivery order, is grouped into subsequences of encoded frames, which are each called a Group of Pictures (GOP) 405. A GOP 405 is made up of an initial I-frame followed by a number of P- and B-frames. The length of a GOP is flexible, but is generally 12-15 frames in length. The delivery order for video frames differs from the presentation order for the frames. In particular, B-frames are delayed and delivered only after the frames upon which they depend have already been delivered. For example, a presentation sequence I B B P is delivered as I P B B. This results in the first B-frames for one GOP potentially being presented before the initial I-frame of that GOP.

A desired out time t_{A} 118 is used to compute out frame f_{A1} 218 that corresponds to a start of a GOP 405 by rounding to the nearest GOP. That is, the out time is mapped to the frame after the presentation of the last P-frame of a GOP, and before the presentation of any B-frames that are delivered in the next GOP. This requirement of mapping to GOP boundaries is relaxed in alternative versions of the system.

New elementary stream ES_{A′1} 430, which corresponds to PES_{A′1} 272 in FIG. 2, delivers the same sequence of frames up to out frame f_{A1} 218 as ES_{A1} 212. These frames are followed by H black frames 410 that are encoded using an initial I-frame, I_{B}, followed by a series of zero-motion P-frames, P_{z}. The zero motion frames consume very little data to encode, for example on order hundreds of bytes, because the image is unchanged from the initial I-frame. The “hold” parameter H is common to all out-transition fragments. For example, H=3, is an example of a suitable choice for the hold parameter.

In presentation order, the assembled sequence of video frames 440 ends in a P-frame, followed by H black frames encoded as an I-frame followed by H-1 zero-motion P-frames.

Out-transition fragment 120 is padded with a number of null transport stream packets (not shown in FIG. 2 or FIG. 4) so that at the end of the delivery of the end of the out-transition fragment aligns approximately (to within plus or minus ½ the delivery time of an 188 byte TS packet) with a particular picture presentation time. This presentation time is chosen so that the H black frames are delivered but not yet presented at the decoder that has received the out-transition fragment. Note that at a data rate of 6 Mb/s, one TS packet is approximately 0.25 ms in duration, which is a small fraction of the typical frame presentation interval of 33.3 ms for television signals.

In certain circumstances, out-transition fragment 120 cannot be padded in this way, for example, because the presentation of audio extends beyond the presentation of video. In such a case, one (or more if necessary) additional black frames, P_{z}, which are in addition to the H pictures needed, are added before the out-transition fragment is padded. The stream is padded with null packets to ensure the conditions described above are met. In essence, if the audio overshoots the video, we add video until this is no longer the case and then proceed as before.

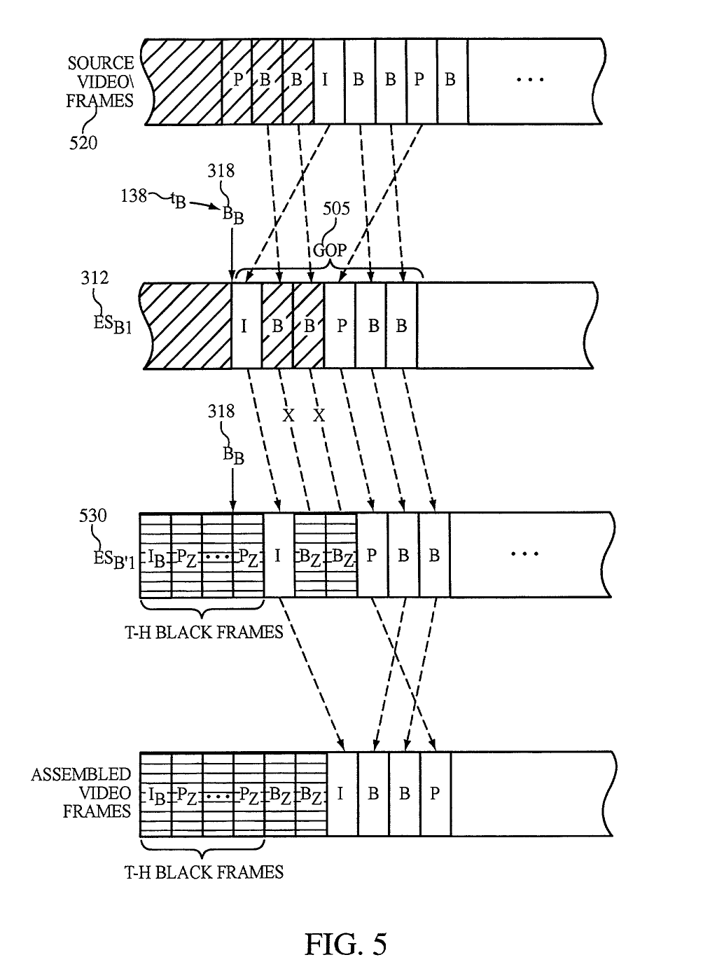

Referring to FIG. 5, desired in-time t_{B} 138 is mapped to an in-frame f_{B1} 318 that corresponds to the start of a GOP 505 in elementary video stream ES_{B1} 312. Note that as discussed above, due to the out of order delivery of frames in ES_{B1} 312, the first I-frame following f_{B1} 318 of the desired portion of the stream may be followed by a number of B-frames that depend on frames prior to f_{B1}. In-transition fragment 140 is constructed such that the resulting elementary video stream ES_{B′1} 530 has a total of T-H black frames for presentation before the I-frame at in frame f_{B1} of ES_{B1} 312. These black frames are made up of one black I-frame, followed by a number of zero-motion P-frames. The “link broken” indicator in the GOP header associated with the I-frame is set so that a decoder can ignore the immediately following B-frames. In practice, video decoders do not necessarily ignore such B-frames following the broken link indicator. Therefore B-frames that are delivered just after the I-frame are replaced with B-frames that do not depend on a picture that would have been delivered before the B-frame. For instance, zero-motion B-frames that depend only on the I-frame are used.

The parameter T depends on the particular stream ES_{B1} 312 and the in-frame f_{B1} 318. In particular, T depends on the decoder delay at the time that the frame at in-frame f_{B1} 318 would have been delivered in the original source stream ES_{B}. The decoder delay is the difference between the delivery time of the frame at offset f_{B1} and the decoding time of that frame. The parameter T is an integer that is equal to the decoder delay divided by the frame presentation interval, rounded up to the next larger integer.

A number of null transport stream packets (not shown in FIG. 5) are inserted after the T-H black frames and before the first I-frame of the desired portion. The number of these null packets is determined such that at the point after that the last of the T-H black frames are delivered and the first I-frame of the desired portion is to be delivered the decoder delay matches the decoder delay that would have been present in the original TS stream at the point that the first I-frame of the desired portion would have been delivered. By matching the decoder delay, the video buffer verifier (VBV) decoder model is guaranteed to be satisfied, and a decoder receiving the assembled stream should not underflow. In addition, because the black frames that are buffered at that point use less data to encode than the frames of the original stream that would have been buffered at that point, the decoder buffer is also guaranteed not to overflow.

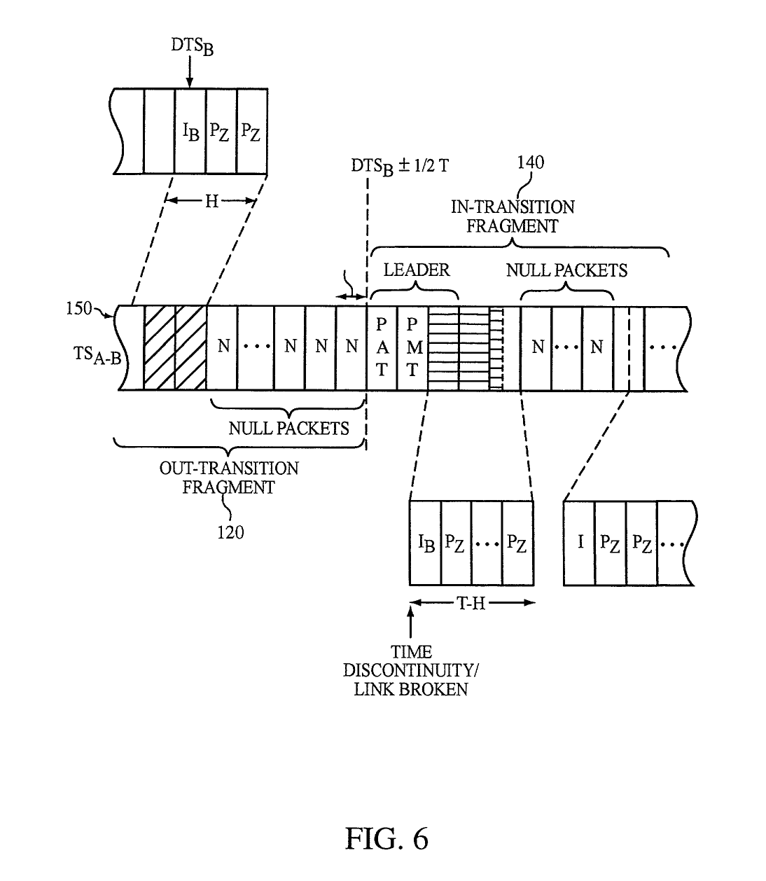

Referring to FIG. 6, the detailed timing near the transition between out-transition fragment 120 and in-transition fragment 140 involves padding the out-transition fragment with null TS packets. In-transition fragment 140 starts with a leader section of a number of TS packets. These packets include a Program Association Table (PAT) and Program Map Table (PMT) for the stream to which the transition is made. The T-H black frames form a GOP that is encoded in TS packets that follow the leader section. The GOP header includes the broken link indicator and indicating a time base discontinuity starting at that GOP.

Recall that the video ES stream in the out-transition fragment finishes with H black MPEG frames, I_{B} P_{Z} . . . P_{Z}. These black frames have time stamps in the time base of the source stream, TS_{A}. Null packets are added to the end of the out-transition fragments so that the delivery time just after the delivery of the last byte of the last null packet, or equivalently, the delivery time of the first packet of the in-transition fragment, is equal to the presentation time of the first of the H black frames within a tolerance of plus or minus ½ a TS packet delivery time.

In the in-transition fragment, a number of initial TS packets, in this embodiment 3 packets, form a leader section. The first of these packet indicates a change of time base to match TS_{B}. This is followed by the TS packets that carry the T-H black frames, a number of null TS packets that are used to adjust the delivery time of the first I-frame, and the desired video frames of in-transition fragment 140.

The decoding time stamps (DTS) of the T-H black frames are computed from the decoding time of the first desired I-frame. To be precise, the decode time for the first of the T-H black frames is DTS[1]=DT−((T-H)*FT) and the presentation time stamps for the sequence to the T-H black frames are PTS[1]=DTS[1]+FT; DTS[2]=DTS[2]+FT and PTS[2]=DTS[2]+FT. In this notation, DTS[n] is the decoding time stamp of the n^{th} of T-H pictures, DT is the decoding time of the first picture in the source stream, and FT is the frame time. The frame time, FT, is expressed in a 90 Khz clock.

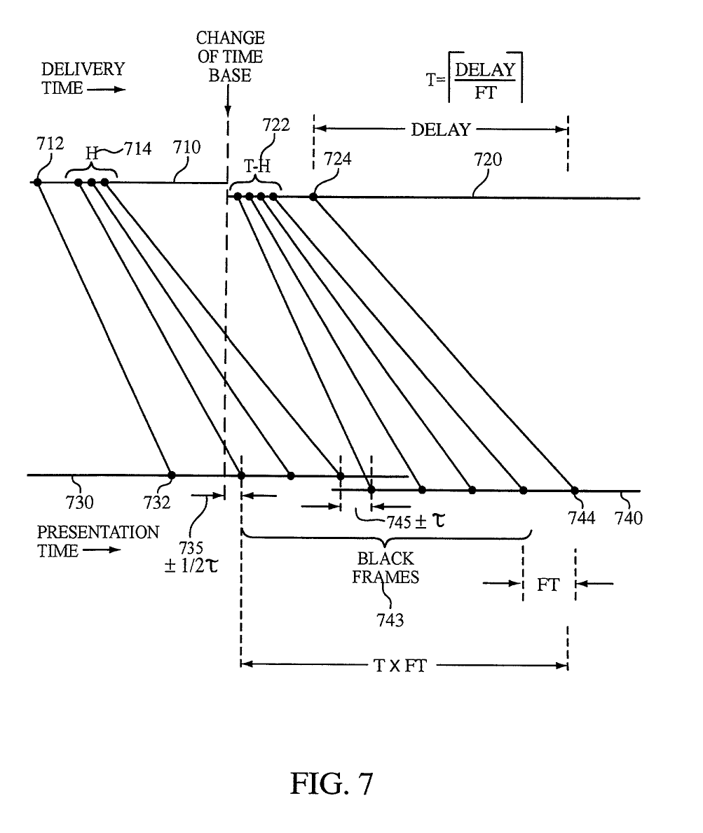

Referring to FIG. 7, this change of time base affects the increment of the frame time (taking into account the change in time base) from the last of the H black frames of the out-transition fragment to the first of the T-H back frames of the intransition fragment. In FIG. 7, timeline 710 is associated with the delivery time in the first time base, and timeline 720 in the second time base. Similarly, timeline 730 is associated with the presentation time in the first time base, and timeline 740 is associated with the presentation time in the second time base. As illustrated, on delivery timeline 710, the last desired frame 712 of the TS_{A} 110 is followed by H black frames 714. As discussed above, the delivery time of the beginning of the in-transition fragment is adjusted using null TS packets in the out-transition fragment such that the presentation time of the first of the H black transition frames 714 coincides with the start of the intransition fragment, plus or minus ½ a TS packet delivery time 735. On delivery timeline 720, the T-H black frames 722 have delivery times well within the first frame time following the transition (not drawn to scale) followed by delivery of the first desired frame 724 of TS_{B}. Also as introduced above, the T-H black frames 722 in the in-transition fragment have presentation times that are equally spaced in increments of one frame time (e.g., 33.3 ms) to match the presentation time of the first frame following the black transition frames. Note that the presentation times of the T-H black frames do not in general fall on whole multiples of a frame time following the delivery time of the first byte of the in-transition fragment, therefore the actual frame time between the last of the H black frames and the first of the T-H black frames may deviate from a standard frame time by as much as one half TS packet time, e.g., 33.3 ms plus or minus 0.25 ms in a 6 Mbps stream.

Fixed equal steps in presentation times for successive MPEG frames is not strictly required by the MPEG standard. However, in practice, some decoders cannot tolerate as a large deviation as 0.25 ms in one step. In an alternative embodiment in which video frames must be presented in exactly equal presentation time increments, the assembled transport stream is retimed by adjusting the time stamps in the stream during or after assembly.

3 Stream End-Points

Transition fragments are also computed at the beginning and end of source streams. For example, a source stream for an advertisement that is to be inserted into a program may have a short duration, for example 30 seconds. At the start of the stream, only an in-transition fragment is computed while at the end of the stream only an out-transition fragment is computed. Computation of these fragments is similar to that described above for out- and in-transition fragments, but differs slightly in details related to the transitions occurring at the end points of the source stream. For example, referring to FIG. 5, there are no delayed B-frames that occur after the first I-frame of the stream, and therefore the zero-motion B-frames do not have to be computed.

4 Audio Streams

Audio frames are independently coded (similar to I-Frames in MPEG video) and as long as the elementary audio streams start and stop on elementary frame boundaries, no audio artifacts are generated. Audio decoders generally deal gracefully (i.e., generate silence) when no audio frame are transmitted. Therefore, in the approach described above, after the audio stream terminates during the transition, silence is presented.

An alternative approach is to transmit audio frames containing silence, or alternatively other appropriate transition sounds, in the out- and in-transition fragments (see PES packets 284A in FIG. 2 and 384 in FIG. 3).

5 System Architecture

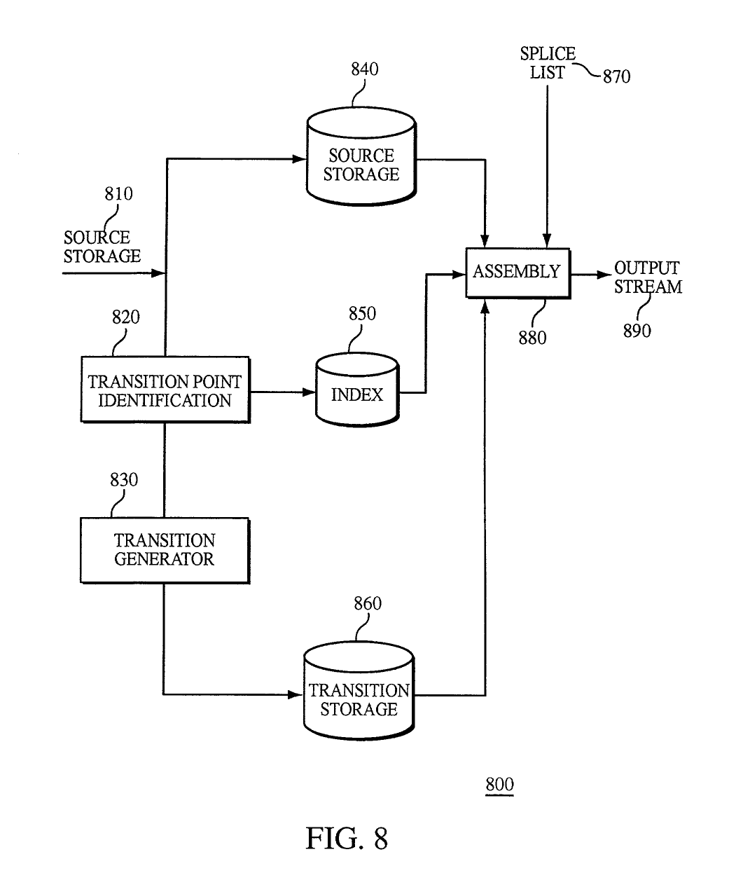

Referring to FIG. 8, a content splicing system 800 for assembling a stream as described in the example above accepts source MPEG transport streams 810 and produces one or more output MPEG transport streams 890, which are formed by assembling various portions of source streams 810. As source streams 810 are input to the system, system 800 stores the streams in a source storage 840, typically RAM or magnetic disk. The source streams are also processed by a transition point identification module 820, which identifies transition points (time and data offsets) in the source transport streams.

Potential transition points may be predefined and provided along with the source stream for example from cue tones with analog sources or from DVS-253 signaling imbedded in digital sources. Such signals identify, for example, times at which advertisements can be inserted. The potential transition points may in addition or alternatively be identified dynamically by the system based on the content of the MPEG stream. For example, automated scene change analysis is performed on the source video to identify potential transition points.

Data identifying the potential transition points is stored in an index 850. For the identified transition points, a transition generator 830 calculates in- and out-transition fragments for those transition points according to the approach described above and these fragments are stored in a transition storage 860, which is also typically RAM or magnetic disk, for example the same disk used for source storage 840.

At a later time, which can be as short as the time needed to compute the transition fragments for a source stream, or can be an extended time before a stream is assembled, an assembly module 880 retrieves portions of source streams 810 that are stored in source storage 840 and retrieves particular transition fragments from transition storage 860, and concatenates the retrieved portions and fragments to form output stream 890. The particular portions of the source streams to be assembled in this way is driven by an assembly list 870, which specifies the offsets at which transitions between different source streams are to occur.

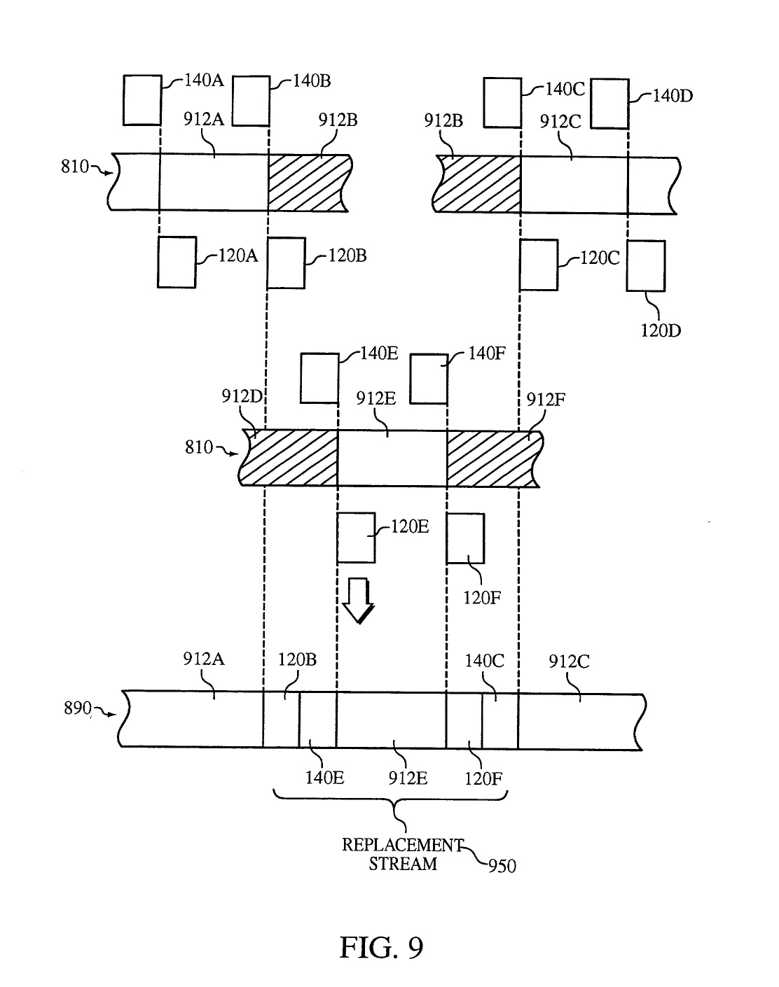

Referring to FIG. 9, source transport stream(s) 810 are indicated with segments 912A-F separated by potential transition points. For each transition point, transition generator 830 generates a corresponding out-transition fragment 140A-F and a corresponding in-transition fragment 120A-F.

In an assembly process in which a program in segment 912B, such as an original commercial, is to be replaced by a program in segment 912E, such as a replacement commercial, the resulting stream 890 includes a replacement stream 950 that is delivered in place of segment 912B. This replacement stream includes out-transition fragment 120B, in-transition fragment 140E, segment 912E, out-transition fragment 120F, and finally in-transition fragment 140C.

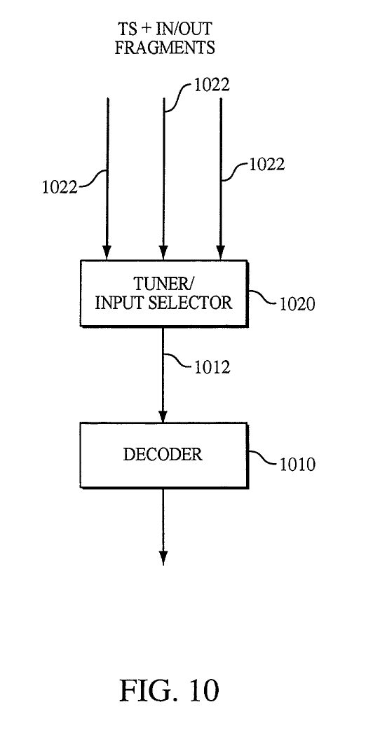

Referring to FIG. 10, in an alternative architecture, the assembly process is performed at a remote location, for example, in a set-top box at a customer premises of a cable television system. One application of this is to replace television commercials with particular commercials that are selected according to the set-top box. In such an application, the set-top box receives an original stream 810 along with an out-transition fragment 120 (such as out-transition fragment 120B for replacement of a commercial in segment 912B) as well as an in-transition fragment (such as in-transition fragment 140C) over one input channel 1022. Alternative commercials segments (for example segment 912E) along with their associated in-transition fragments (for example, fragment 140E) and out-transition fragments (for example, fragment 120F) are transmitted on other input channels 1022. A tuner/input selector 120 dynamically selects the appropriate input channel for the commercial. To the extent that the duration of the original commercial segment 912B is equal to the replacement stream 950, which includes the pair of out- and in-transition fragments at each end of the replacement commercial, no retiming or buffering of the source stream 810 is needed to continue after the commercial. Null TS packets at the points where the tuner selects a different channel allow the packets to be lost without loosing necessary content. Various types of input channels 1022 for the alternative commercials can be used. For example, these channels may correspond to different delivery channels in the cable television system. Alternatively, the alternative commercials can be delivered and buffered in the set-top box until they are presented.

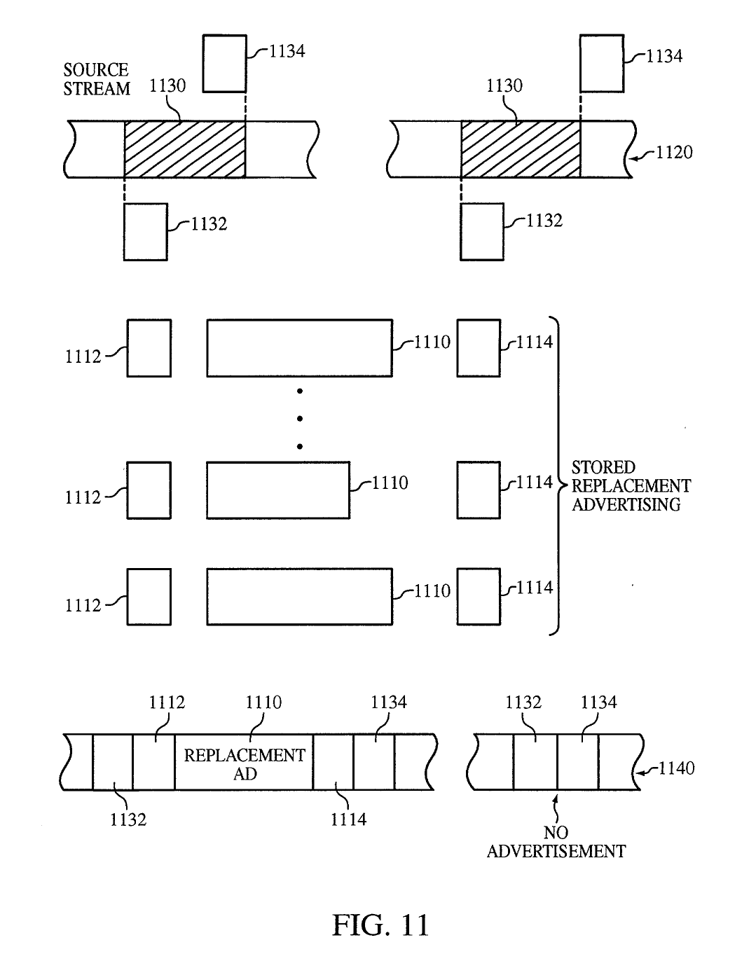

Referring to FIG. 11, an advertisement replacement system involves storing a number of advertisement transport streams 1110. For each advertisement stream, an in-transition fragment 1112 associated with the start of the advertisement stream, and an out-transition fragment 1114 associated with the end of the stream are stored. Note that for any particular advertisement, the in-transition fragment 1112, the advertisement stream 1110 itself, and the out-transition fragment 1114 may be stored together as one sequence of TS packets without necessarily identifying the boundaries between the three components. A source program 1120 is accepted by the system. The source program includes a number of original advertisements 1130. For each advertisement, an out-transition fragment 1132 is stored associated with the start of the advertisement, and an in-transition fragment 1134 is associated with the end of the advertisement. These in-and out-transition fragments may be computed and delivered to the system in conduction with the source program, computed in a batch if the source program is stored, or computed “on-the fly” shortly before the advertisement would be delivered.

During delivery, each original advertisement 1130 can be replaced by zero or more advertisements 1110 to form a new stream 1140. An insertion of a single replacement advertisement corresponds to replacing original advertisement 1130 with out-transition fragment 1132, in-transition fragment 1112, the replacement advertisement stream 1110, the out-transition fragment 1114 for the replacement advertisement, and the in-transition fragment 1134 for the original advertisement. If no advertisement is to be presented, the original advertisement 1130 is replaced by the out-transition fragment 1132 followed by the in-transition fragment 1134 associated with the original advertisement. Multiple advertisements can be concatenated with an out-transition and in-transition fragment between each advertisement to replace a single original advertisement in similar manner.

Another application involves presentation of selected portions of a program by presenting short segments in succession. In this application, transition fragments display frozen frames. For example, to present an initial portion of each of a sequence of scenes, an in-transition fragment is associated with the start of the scene, and out-transition fragments are associated with one or more points in the scene. In operation, presentation of a “fast-forward” version of a program involves replacing a trailing portion of each scene with an out-transition fragment followed by an in-transition fragment of the next scene. Selection of the out-transition point in each scene then determines the “speed” of the fast forward presentation.

6 Alternatives

In the embodiments described above, an out-transition fragment and an in-transition fragment are concatenated when assembling a stream. In one alternative, rather than concatenating the out- and in-transition fragments, the fragments are “woven” together. Recall that both the out-transition fragment and the in-transition fragment in general have a number of null TS packets. In particular, each out-transition fragment has a number of trailing null TS packets, as shown in FIG. 6. If a number of null packets whose delivery time is equal to the presentation time of one frame are removed from the transition, and one of the T-H black frames is also removed from the in-transition fragment then the duration of the black transition is shorter by one frame, and the transition still forms a compliant MPEG stream. In order to make removal of black frames efficient, each of the frames is encoded in a separate PES packet in set of TS packets in the in-transition fragment. Deletion of the black frame then corresponds to deletion of the associated TS packets for that PES packet. The process can be repeated until the T-H black frames of the null packets in the out-transition fragment are exhausted.

Rather than mapping a desired splice time (a desired in-time and out-time) in a source transport stream to a particular frame in each elementary stream of the source transport stream, an alternative is to map the desired time into a cluster of different frames in each elementary stream. In- and out-transitions are then generated for each of these frames. The cluster is used, for example, when cue timing is inaccurate. When a default frame for a desired splice time does not match visually where the stream should be entered or left, the frame is manually corrected by selecting another frame (and corresponding transition fragments) from the cluster.

Rather than generate a cluster of splice points requiring after-the-fact manual correction of a miss timed splice cue, in an alternative approach, content near the splice point is analyzed and an in-frame and an out-frame (which may be different) are picked to best match a profile of what is expected in an ad replacement scenario. One example is to analyze at the overall brightness of the pictures around the splice point and pick the darkest. Note, however, that opportunities to replace ads are typically demarked with a short black interval in the original program signal. Therefore, another approach is to leave the stream at the point where the black interval begins and return to the stream as close as possible to where the black interval ends. This offers the benefit of replacing the original black sequence with a black splice transition sequence, thus reducing or eliminating the perceived effect of the splice altogether.

Mapping a desired transition to a frame at a GOP boundary is not necessary. For example, with little added computation out-points can be aligned to P-Frame boundaries inside of GOPs, thereby yielding more accurate out transitions. With somewhat more computation, out-points and in-points can also be created at any frame, for example, by recoding a portion of the GOP containing the transition.

The approaches described above for fixed-rate delivery of transport streams are equally applicable to variable-rate delivery. Also, the approach is not limited to multimedia streams encoded according to the MPEG standard.

Other pictures rather than black frames can be encoded during the in- and out-transitions, subject to using relatively few bits thereby avoiding buffer overflow during presentation of the spliced stream. Furthermore, transition effects, such as a frozen frame or a gradual fade, can be encoded in the transition fragments. In alternative embodiments in which a frozen frame is to be displayed throughout the entire transition, the in-transition fragment does not include an initial I-frame, and uses zero-motion predictive frames that depend of images encoded in the out-transition fragment. That is, a GOP spans both the out- and the in-transition fragment.

Rather than retaining the MPEG encoding of pictures into their original I-, P-, and B-frames, computation of the transition fragments can alternatively include decoding and recoding certain of the MPEG frames, for example, to adjust the degree of compression in the MPEG stream.

In-transition and out-transition fragments need not be concretely represented. Rather, parameters that can be used to generate each of these fragments can be computed and the transition fragments are then dynamically generated from the parameters at assembly time.

Rather than encoding frames in the transition fragments using sequences of a black I-frame followed by zero-motion P-frames of the form IPPPPPP . . . , an alternative is to use a sequence of frames that includes zero-motion B frames. Such sequences can have the form IBBPBBP . . . . Such a form is typically used to encode video programming, and the decoders of some set-top boxes may expect that form and may not, in fact properly, process sequences made up of only zero-motion P frames. When using zero-motion B-frames, the presentation and decoding time stamps of the frames are adjusted accordingly.

The description above concentrates on assembling MPEG streams. The same approach can be applied to other types of multimedia streams, including other versions of the MPEG standard, as well as multimedia streams encoded using other standards.

7 Implementation

An approach to implementing the methods described above uses software that is accessed by a computer processor, for example, from a storage disk or over a local area network. The computer executes the software under the control of an operating system. One example is a general purpose Intel Pentium processor executing the software under a Microsoft Windows operating system. Other general purpose or special purpose processors, and other software environments can alternatively be used. Pre-computation of transition fragments and assembly of the streams can be performed by the same computer or computers, or different computers can be used for computation of the transition fragments and the assembly. Furthermore, transition fragments can be computed remotely and delivered to a computer that hosts the assembly process. In such a case, the transition fragments can be delivered together with, or separately from, the stream for which they have been computed. In alternative implementations, some or all of the functions are performed by special purpose circuitry, which may include programmed processors.

Other embodiments are within the scope of the following claims.

What is claimed is:

1. A method comprising:
enabling assembly of any of a plurality of output multimedia streams from segments of source multimedia streams, including computing stream fragments for insertion between successive ones of the segments to form any of the output streams.

2. The method of claim 1 further comprising determining the segments of the source streams from desired presentation time boundaries for said segments.

3. The method of claim 1 wherein enabling assembly of the output streams further includes storing at least some of the stream fragments prior to assembly.

4. The method of claim 3 wherein storing the stream fragments includes storing said fragments in a disk storage.

5. The method of claim 1 wherein the stream fragments are for concatenation between successive segments.

6. The method of claim 5 wherein the stream fragments are for concatenation without modification to form any of the output streams.

7. The method of claim 1 wherein each of the source multimedia streams, each of the output multimedia streams, and each of the stream fragments comprise temporally encoded streams.

8. The method of claim 7 wherein the temporally encoded streams comprise MPEG streams.

9. The method of claim 8 wherein each of the MPEG streams comprise MPEG transport streams.

10. The method of claim 7 wherein enabling assembly of the output streams includes enabling assembly of output streams that each includes a video stream, such that the video stream encodes a presentation of a continuous sequence of video frames.

11. The method of claim 1 wherein each of the video streams avoids overflow or underflow of a Video Buffer Verifier model.

12. The method of claim 1 further comprising assembling a first of the output multimedia streams from a series of the segments.

13. The method of claim 12 wherein computing the stream fragments is performed prior to assembling the first output stream.

14. The method of claim 12 wherein computing the stream fragments is performed independently of assembling the first output stream.

15. The method of claim 12 wherein enabling assembly of the streams includes storing at least some of the stream fragments, and assembling the first output stream includes retrieving said fragments.

16. The method of claim 12 wherein assembling the first output stream includes inserting one or more of the stream fragments between each successive pair of the segments in the series.

17. The method of claim 16 wherein inserting the stream fragments between each successive pair of segments includes inserting the two stream fragments between said segments.

18. The method of claim 17 assembly of the output stream includes concatenating the two stream fragments.

19. The method of claim 12 further comprising assembling a second of the output multimedia streams from a series of segments.

20. The method of claim 19 wherein assembling the first and the second output streams includes inserting at least some of the computed stream fragments into both the first output stream and the second output stream.

21. The method of claim 1 further comprising assembling a first plurality of the output multimedia streams, and wherein at least some of the computed stream fragments are not used in assembling any of the streams of said first plurality of output streams.

22. The method of claim 1 wherein enabling assembly of any of the output streams includes enabling assembly of a succession of any of a first plurality of the stream segments and any of a second plurality of stream segments.

23. The method of claim 22 wherein computing the stream fragments includes computing stream fragments each associated with a transition from a different one of the first plurality of segments, and computing stream fragments each associated with a transition to a different one of the second plurality of stream segments.

24. A method for dynamic assembly of multimedia streams comprising:
storing information for each of a plurality of replacement segments, including for each replacement segment, storing a stream fragment associated with the beginning of the replacement segment and a stream fragment associated with the end of the replacement segment;
for each of one or more original segments of a source multimedia stream, replacing the original segment with one of the stored replacement segments, including inserting a stream fragment associated with each of the original segment and the replacement segment at each transition between the source stream and the replacement segment.

25. A method for assembling a multimedia stream comprising:
identifying transition points in one or more multimedia streams, including identifying a first transition point in a first of the streams and a second transition point in a second of the streams;
computing stream fragments each associated with one of the transition points in the streams, including computing a first stream fragment associated with the first transition point in the first stream and computing a second stream fragment associated with the second transition point in the second stream;
assembling the multimedia stream from elements including a portion of the first stream prior to a first transition point,
the first stream fragment,
the second stream fragment, and
a portion of the second stream following the second of the transition point.

26. The method of claim 25 wherein assembling the multimedia stream includes concatenating the elements.

27. The method of claim 26 wherein the elements are portions of MPEG transport streams and concatenating the elements forms a new MPEG transport stream.

28. The method of claim 27 wherein the portions of the MPEG transport streams are formed of sequences of transport stream packets.

29. The method of claim 25 wherein computing the stream fragments includes computing each stream fragment independently of transition points other than the one with which said fragment is associated.

30. The method of claim 25 wherein computing the stream fragments is performed prior to the assembling the stream.

31. The method of claim 30 further comprising storing the computed stream fragments on a storage device, and assembling the stream includes retrieving the first and the second stream fragment from said storage device.

32. The method of claim 24 wherein the one or more multimedia streams are MPEG streams.

33. The method of claim 32 wherein the MPEG streams are MPEG transport streams.

34. Software stored on computer-readable media for causing a computer system to perform functions comprising:
enabling assembly of any of a plurality of output multimedia streams from segments of source multimedia streams, including computing stream fragments for insertion between successive of the segments to form any of the output streams.

35. A multimedia processing system comprising:
means for enabling assembly of any of a plurality of output multimedia streams from segments of source multimedia streams, including computing stream fragments for insertion between successive of the segments to form any of the output streams.
